(19) United States
(12) Patent Application Publication
(10) Pub. No.: US 2006/0055759 A1
(43) Pub. Date: Mar. 16, 2006

(54) Mechanism for temporarily stocking recording sheet material and printer equipped with the same

(76) Inventor: Hiroyuki Kohira, Chiba-shi (JP)

Correspondence Address: BRUCE L. ADAMS, ESQ., 17 BATTERY - PLACE-SUITE 1231, NEW YORK, NY, 10004, US

(21) Appl. No.: 11/196,096

(22) Filed: Aug. 3, 2005

(30) Foreign Application Priority Data
Sep. 14, 2004 (JP) 2004-267372

(51) Int. Cl. B41J 2/01

(52) U.S. Cl. 347/104

(57) ABSTRACT

Disclosed are a sheet material stocking mechanism providing a large stocking capacity with a small space and a printer equipped with such a stocking mechanism. A thermal printer is composed of a roll accommodating unit (2) retaining a heat sensitive adhesive sheet (1) wound into a roll, a printing unit including a printing thermal head (4) for performing printing on the heat sensitive adhesive sheet (1), a cutter unit (3) for cutting the heat sensitive adhesive sheet (1), a stocking unit including a cylindrical member (10) for temporarily stocking the heat sensitive adhesive sheet (1) that has undergone printing in a state in which it is wound into a cylindrical roll, and a thermal activation unit including a thermal activation thermal head (6) that thermally activates a heat sensitive adhesive agent layer of the heat sensitive adhesive sheet (1).

### BACKGROUND OF THE INVENTION

1. Field of the Invention

The present invention relates to a printer that performs recording on a sheet material, in particular, a mechanism for temporarily stocking a sheet material that has undergone recording. The sheet materials to which the present invention is applicable include, apart from an ordinary sheet material such as a paper sheet which allows recording on one side or both sides thereof, a sheet material having a thermal activation adhesive surface which develops an adhesion property by being heated on the back side of the recording surface (printing surface), and a sheet material having on the back side of the recording surface an adhesive surface with a release sheet (liner) attached thereto.

2. Description of the Related Art

Conventionally, as disclosed in JP 2003-316265 A, there has been available an apparatus which, after recording on a sheet material serving as a recording material, temporarily stocks the sheet material for the purpose of cutting the sheet material in a predetermined length.

The apparatus disclosed in JP 2003-316265 A is a printer applicable to a sheet material having a recording surface on which recording, such as printing, is effected, and a thermal activation surface which develops an adhesion property by being heated on the back side of the recording surface.

This printer is equipped with a printing apparatus, a cutter device, and a thermal activation apparatus. The printing apparatus has a printing means for performing printing on a recording surface of a sheet material, and a first conveying means for conveying the sheet material in a predetermined direction. The cutter device is provided on the output side of the printing apparatus, and the thermal activation apparatus is provided on the output side of the cutter device. The thermal activation apparatus has a heating means for heating the side of the sheet material reverse to the recording surface, and a second conveying means for conveying the sheet material in a predetermined direction. Between the cutter device and the thermal activation apparatus, there is provided a space portion capable of deflecting the sheet by a predetermined length.

In this printer, constructed as described above, printing is performed on the recording surface of the sheet material while conveying the sheet material by the first conveying means, and then the thermal activation adhesive surface on the side of the sheet material reverse to the recording surface is heated while conveying the sheet material by the second conveying means.

In this process, the conveying speed of the second conveying means is set higher than the conveying speed of the first conveying means, whereby the sheet material is deflected in the space portion between the cutter device and the thermal activation apparatus. When the sheet material has been deflected by a predetermined length, the operation of the printing means and the first conveying means is stopped while continuing the operation of the heating means and the second conveying means, and the sheet material is cut by the cutter device.

While in the apparatus disclosed in JP 2003-316265 A, the sheet material is temporarily stocked by deflecting it into a U-shape, there is another known method according to which the sheet material is stocked by deflecting it into a bellows-like fashion.

As another conventional apparatus equipped with a mechanism for temporarily stocking a recording sheet, there exists a printer as disclosed in JP 2001-261228 A. In the printer as disclosed in the above-mentioned publication, when the leading end of the sheet material undergoing printing sticks out of the discharge port of the apparatus casing, the sheet material is pulled or pressurized to cause recording drift, jamming, etc. before the completion of the recording or sheet cutting; to prevent such inconvenience, the sheet material is stocked inside the apparatus until the recording and sheet cutting have been completed, the sheet material being discharged to the exterior of the apparatus through a discharge port after the completion.

This apparatus is equipped with a space in which the sheet that has undergone recording is kept dangling by its own weight while held by a driving roller and a driven roller. The sheet that has undergone recording is temporarily stocked in this space, and when the recording and sheet cutting have been completed, the driving roller makes reverse rotation to switch the sheet conveying direction, the sheet that has undergone recording and cutting being discharged to the exterior of the apparatus through the discharge port.

The mechanism for temporarily stocking the recording material as disclosed in JP 2003-316265 A and JP 2001-261228 A adopts a system in which the sheet material that has undergone recording is deflected into a U-shape or in a bellows-like fashion or kept dangling in a predetermined space until a predetermined processing, such as recording or sheet cutting has been completed.

Thus, the mechanism has a problem in that the larger the length of one sheet required from recording on the sheet material to the cutting thereof, the larger the space that must be prepared for the stocking of the sheet material. In other words, depending on the size of the sheet material stocking space, the length of one sheet allowing recording is restricted.

Further, when the size of the space for stocking the sheet material is increased, the size of the apparatus main body becomes rather large. Thus, the temporary stocking mechanism as disclosed in JP 2003-316265 A and JP 2001-261228 A cannot be applied to a small-size mobile printer that can be easily carried about with one hand.

### SUMMARY OF THE INVENTION

In view of the above problem in the prior art, it is an object of the present invention to provide a stocking mechanism for a sheet-like recording material providing a large stocking capacity with a small space, and a printer equipped with such a stocking mechanism.

To achieve the above object, in accordance with the present invention, there is provided a temporary stocking mechanism for a recording material which temporarily stocks a sheet-like recording material before executing a predetermined processing thereon, characterized by including a member forming a cylindrical or spiral space for stocking the sheet-like recording material.

According to the above-mentioned construction, the sheet-like recording material introduced into the cylindrical or spiral space is gradually wound into a cylindrical roll along an inner wall of a component as it advances. The sheet-like recording material making one roll in the space is then wound along its inner surface. At this time, movement of the sheet-like recording material assists winging of the sheet-like recording material.

Therefore, when the sheet-like recording material is temporarily stocked, it is possible to stock the sheet-like recording material in a state in which it is taken up in a cylindrical fashion.

As described above, according to the present invention, the sheet-like recording material is stocked in a state in which it has been taken up in a cylindrical fashion, so that there is no need to prepare a large space for stocking the sheet-like recording material, thereby achieving a reduction in apparatus size. Further, since the sheet-like recording material is wound along its inner surface in the cylindrical or spiral stocking space, the sheet length allowing stocking is not restricted by the volume of the stocking space.

Further, the temporary stocking mechanism of the present invention provides a large stocking capacity with a small space, so that it is also applicable to a small-size mobile printer.

### BRIEF DESCRIPTION OF THE DRAWINGS

In the accompanying drawings:

FIG. 1 is a schematic diagram showing the construction of a thermal printer according to an embodiment of the present invention;

FIGS. 2A and 2B are schematic diagrams illustrating the operation of the thermal printer of FIG. 1;

FIGS. 3A and 3B are schematic diagrams illustrating the operation of the thermal printer of FIG. 1; and

FIGS. 4A and 4B are schematic diagrams illustrating the operation of the thermal printer of FIG. 1.

### DESCRIPTION OF THE PREFERRED EMBODIMENT

An embodiment of the present invention will now be described with reference to the drawings.

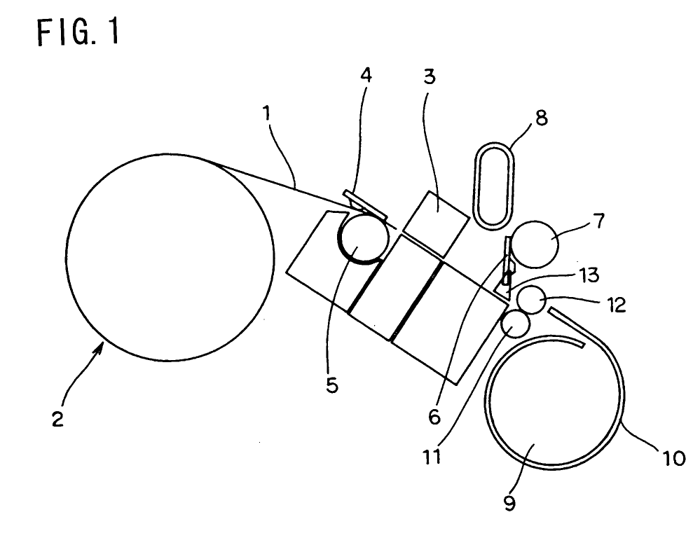

FIG. 1 is a schematic diagram showing the construction of a thermal printer according to an embodiment of the present invention.

The thermal printer as shown in FIG. 1 is composed of a roll accommodating unit 2 retaining a tape-like heat sensitive adhesive sheet 1, a printing unit including a printing thermal head 4 for performing printing on the heat sensitive adhesive sheet 1, a cutter unit 3 for cutting the heat sensitive adhesive unit 1, a stocking unit including a cylinder member 10 for temporarily stocking the heat sensitive adhesive sheet 1 that has undergone printing in a state in which the heat sensitive adhesive sheet 1 is wound into a cylindrical roll, and a thermal activation unit including a thermal activation thermal head 6 for thermally activating the heat sensitive adhesive agent layer of the heat sensitive adhesive sheet 1. Further, this printer is equipped with a conveying direction switching means 13 for switching between the direction in which the heat sensitive adhesive sheet 1 that has undergone printing by the printing thermal head 4 and passed through the cutter unit 3 is conveyed into the cylinder member 10, and the direction in which the heat sensitive adhesive sheet is conveyed from within the cylinder member 10 of the stocking unit toward the thermal activation thermal head 6 of the thermal activation unit. In this specification, the term “printing” includes the image formation of not only characters and figures but also of pictures, patterns, etc.

The heat sensitive adhesive sheet 1 has a construction in which a heat insulating layer and a heat sensitive coloring layer (layer allowing printing; hereinafter also referred to as the “printable layer”) are formed, for example, on the obverse side of a sheet base material, and in which a heat sensitive adhesive agent is applied to and dried on the reverse side of the sheet material to form a heat sensitive adhesive agent layer. The heat sensitive adhesive agent layer consists of a heat sensitive adhesive agent whose main component is a thermoplastic resin, a solid plastic resin, or the like. Further, the heat sensitive adhesive sheet 1 may also be one having no heat insulating layer or one having on the surface of the heat sensitive layer a protective layer or a colored printed layer (a layer that has previously undergone printing).

The printing thermal head 4 of the printing unit has a plurality of heat generating elements consisting of a plurality of relatively small resistors arranged in the width direction so as to allow dot printing. The printing unit is equipped with a printing platen roller 5 held in press contact with the printing thermal head 4.

Further, the above printing unit is equipped with a drive system (not shown) adapted to rotate the printing platen roller 5 and composed, for example, of a stepping motor and a gear row or the like; by rotating the printing platen roller 5 in a predetermined direction by this drive system, the heat sensitive adhesive sheet 1 attached to the roll accommodating unit 2 is pulled out of the roll, and sent out in a predetermined direction while undergoing printing by the printing thermal head 4. In FIG. 1, the printing platen roller is rotated clockwise, and the heat sensitive adhesive sheet 1 is conveyed obliquely downward to the right as seen in the drawing. Further, the above printing unit is equipped with a pressurizing means (not shown) consisting of a coil spring, a plate spring, or the like, and, by the elastic force of this pressurizing means, the printing plate roller 5 is pressed against the printing thermal head 4. At this time, the axial direction of the rotation shaft of the printing platen roller 5 and the heat generating element arranging direction in the printing thermal head 4 are kept parallel to each other, whereby press contact can be effected uniformly over the entire range in the width direction of the heat sensitive adhesive sheet 1.

The cutter unit 3 serves to cut the heat sensitive adhesive sheet 1 that has undergone printing by the printing thermal head 4 in a predetermined length, and is composed of a movable cutting edge (not shown) operated by a drive source (not shown), such as an electric motor, a stationary cutting edge (not shown) opposed to the movable cutting edge, etc.

The cylinder member 10 of the stocking unit is fixed in position while forming a stocking space 9 for stocking the heat sensitive adhesive sheet 1, which has undergone printing and has been conveyed, in the form of a cylindrical roll. Further, the cylinder member 10 has a shape in which one plate is wound into a cylindrical roll so that its both ends overlap one another and a gap between the overlapped ends serves as an entrance of the heat sensitive adhesive sheet 1. Provided immediately before the entrance are a conveying roller 11 for conveying the heat sensitive adhesive sheet 1 that has undergone printing and a driven roller 12 adapted to be driven to rotate while pressurized by the conveying roller. While the conveying roller 11 and the driven roller 12 hold the heat sensitive adhesive sheet 1 conveyed through the printing unit, they introduce the heat sensitive adhesive sheet 1 into or extract it out of the cylinder member 10. Switching between the introduction and extraction of the heat sensitive adhesive sheet 1 is performed by changing a rotational direction of the conveying roller 11. Note that the stacking space 9 of the heat sensitive adhesive sheet 1 is formed into a cylindrical shape by the cylinder member 10 but not limited thereto. A member obtained by spirally winding one plate may form the space.

In this embodiment, the thermal activation thermal head 6 of the thermal activation unit described above is of a construction similar to that of the printing thermal head 4, that is, it is of a construction similar to that of the printing head of a well-known thermal printer, which is formed by providing a protective layer of crystallized glass on the surface of a plurality of heat generating resistors formed on a ceramic substrate by the thin-film technique. In this way, as the thermal activation thermal head 6, one of the same construction as the printing thermal head 4 is used, whereby it is possible to use the same component for different purposes, thereby achieving a reduction in cost. It should be noted, however, that it is not necessary for the heat generating element of the thermal activation thermal head 6 to be divided in dot units as in the case of the heat generating element of the printing thermal head 4; it may be a continuous resistor.

The above thermal activation unit is equipped with a thermal activation platen roller 7 held in press contact with the thermal activation thermal head 4, and a discharge roller 8 for discharging the thermally activated heat sensitive adhesive sheet 1 to the exterior of the apparatus casing.

Further, the thermal activation unit is equipped with a drive system adapted to rotate the thermal activation platen roller 7 and composed, for example, of a stepping motor and a gear row or the like; by this drive system, the thermal activation platen roller 7 is rotated clockwise, and the heat sensitive adhesive sheet 1 is conveyed upwards as seen in the drawing. Further, the thermal activation unit is equipped with a pressurizing means (e.g., a coil spring or a plate spring) for pressing the thermal activation platen roller 7 against the thermal activation thermal head 6. In this regard, by keeping the axial direction of the rotation shaft of the thermal activation platen roller 7 and the heat generating element arranging direction in the thermal activation thermal head 6 parallel to each other, it is possible to effect press contact uniformly over the entire range in the width direction of the heat sensitive adhesive sheet 1.

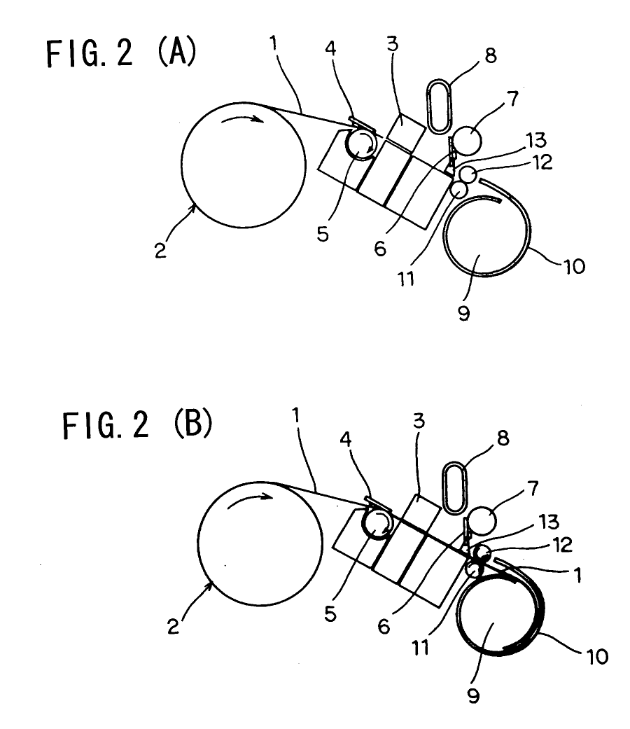

Next, the operation of the thermal printer of this embodiment will be described with reference to FIGS. 2A through 4B. FIGS. 2A through 4B are schematic diagrams illustrating the operation of the printer of FIG. 1.

First, the heat sensitive adhesive sheet 1 wound into a roll is attached to the roll accommodating unit 2. When, thereafter, the heat sensitive adhesive sheet 1 is conveyed to the printing unit, the printing platen roller 5 rotates, and printing control of the printing thermal head 4 is started. As shown in FIG. 2A, the heat sensitive adhesive sheet 1 is held between the printing platen roller 5 and the printing thermal head 4, and, as it is pulled out of the roll accommodating unit 2 through rotation of the printing platen roller 5, printing is performed on the printable layer (heat sensitive coloring layer) by the printing thermal head 4.

Then, the heat sensitive adhesive sheet 1 is delivered from the printing unit through rotation of the printing platen roller 5, and conveyed to the cutter unit 3 constituting the next stage.

After it has passed the cutter unit 3, the leading end of the heat sensitive adhesive sheet 1 is directed toward the stocking unit by the conveying direction switching means 13, and is caught between the conveying roller 11 and the driven roller 12 being rotated.

As shown in FIG. 2B, the heat sensitive adhesive sheet 1 is conveyed through rotation of the conveying roller 11 and the driven roller 12, and is introduced into the stocking space 9 in the cylinder member 10.

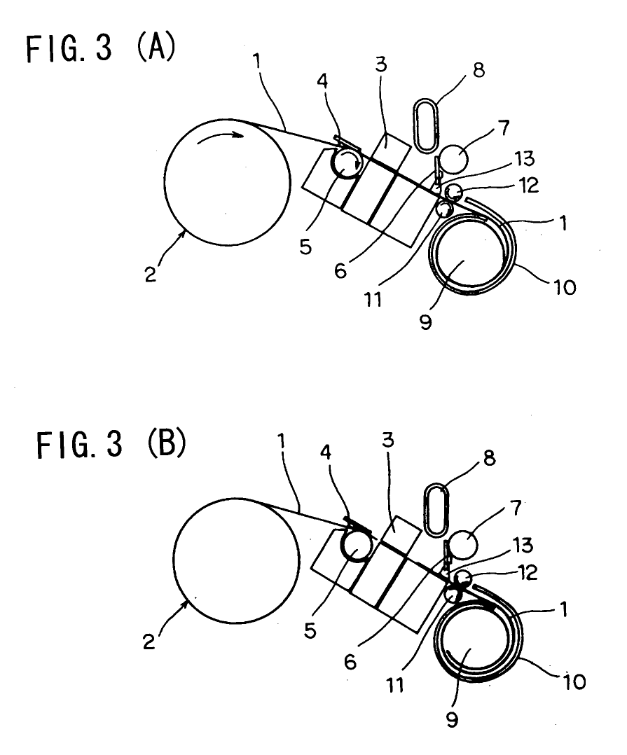

As it advances, the heat sensitive adhesive sheet 1 introduced into the stacking space 9 is gradually wound into a cylindrical roll along an inner wall of the cylinder member 10. The heat sensitive adhesive sheet 1 making one roll in the stacking space 9 is then wound along its inner surface as shown in FIG. 3A. At this time, movement of the conveyed heat sensitive adhesive sheet 1 assists winging of the heat sensitive adhesive sheet 1. Also, depending on the cases, a rotary member for assisting the winding may be provided in the stocking space 9.

When, thereafter, the printing operation by the printing thermal head 4 is completed, the rotating operation of the printing platen roller 5 and the conveying roller 11 is stopped, and the heat sensitive adhesive sheet 1 is cut at a desired position by the cutter unit 3.

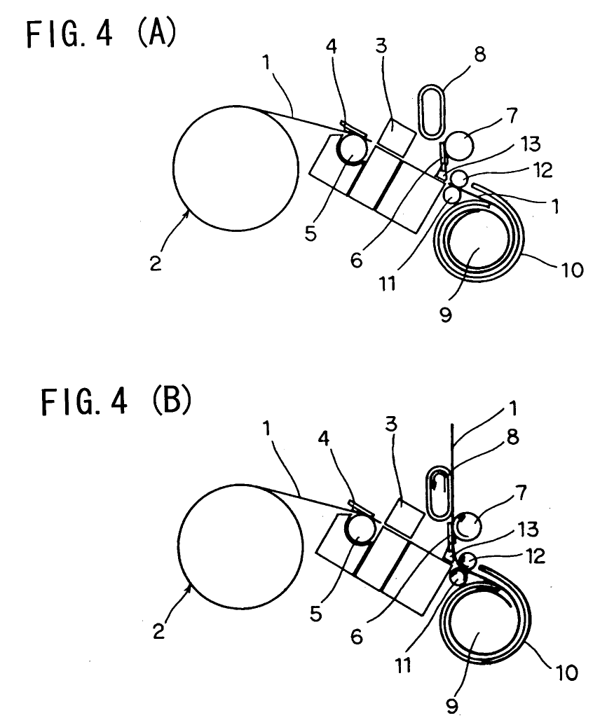

After the cutting, the rotating operation of the conveying roller 11 is started again as shown in FIG. 3B, and the conveying roller 11 is driven until the trailing end of the heat sensitive adhesive sheet 1 that has been cut reaches the gap between the conveying roller 11 and the driven roller 12 as shown in FIG. 4A. At this time, the leading end portion of the heat sensitive adhesive sheet 1 that has been cut is further taken up in the stocking space 9.

Thereafter, as shown in FIG. 4B, the conveying roller 11 is reversed to rotate counterclockwise. As a result, the heat sensitive adhesive sheet 11, which is temporarily stocked in the stocking space 9 in the form of a cylindrical roll is pulled out of the cylinder member 10. In this process, the conveying direction of the heat sensitive adhesive sheet 1 temporarily stocked is switched to the thermal activation unit side by the conveying direction switching means 13.

When the heat sensitive adhesive sheet 1 temporarily stocked in the stocking unit is conveyed to the thermal activation unit, the thermal activation platen roller 7 rotates, thereby starting heating control of the thermal activation thermal head 6. At this time, rotation control of the printing platen roller 5 remains interrupted. The heat sensitive adhesive sheet 1 delivered from the stocking space 9 is caught between the thermal activation platen roller 7 and the thermal activation thermal head 6, and as it is conveyed through rotation of the thermal activation platen roller 7 and the conveying roller 11, the heat sensitive adhesive agent layer is heated by the thermal activation thermal head 6.

The heat sensitive adhesive sheet 1 of a predetermined length, which has undergone printing, cutting, and heating as described above, is discharged to the exterior of the apparatus through rotation of the discharge roller 8, and is attached as it is to a cardboard, a food wrapper, a glass bottle, a plastic container, etc. as an indicator label.

As described above in relation to the printer operation, the thermal printer of this embodiment adopts cylindrical space formed inside the cylindrical member as the space for temporarily stocking the heat sensitive adhesive sheet 1 that has undergone printing prior to executing cutting and thermal activation processing, so that it is possible to stock the heat sensitive adhesive sheet 1 in a state in which it has been taken up in a cylindrical form. Thus, there is no need to prepare a large space for the stocking of the heat sensitive adhesive sheet 1, thereby making it possible to achieve a reduction in apparatus size. Further, the heat sensitive adhesive sheet 1 is wound along the inner surface of the sheet that has been wound in a cylindrical form within the stocking space, so that the sheet length allowing stocking is not restricted by the volume of the stocking space.

The printer of the present invention is not restricted to the embodiment specifically described above, but allows various modifications without departing from the gist of the invention.

For example, while in the above-described embodiment a heat sensitive type printing device like a thermal printer is applied as the printing unit, the present invention is also applicable to printing devices of the thermal transfer system, the ink jet system, the laser printing system, etc. In this case, instead of the heat sensitive printing layer, a sheet material which has undergone a processing suitable for the printing system adopted is used as the printable layer of the sheet material.

Further, the mechanism for temporarily stocking a sheet-like recording material of the present invention, which is of the apparatus construction as shown in FIG. 1, is also applicable to a two-side printing type printer in which the thermal activation unit is replaced by a printing unit, or to a printer which is equipped with no thermal activation unit. In this case, instead of the heat sensitive adhesive sheet, there is used, for example, an ordinary paper sheet or a sheet material with a release sheet (liner) attached to the back side of the recording surface thereof.

What is claimed is:

1. A temporary stocking mechanism for a recording material which temporarily stocks a sheet-like recording material before executing a predetermined processing on the sheet-like recording material, comprising a member forming a cylindrical or spiral space for stocking the sheet-like recording material.

2. A temporary stocking mechanism for a recording material according to claim 1, further comprising a conveying means for performing one of introducing the sheet into the cylindrical or spiral space and extracting the sheet from the cylindrical or spiral surface.

3. A printer comprising: a printing device having a printing means for printing on one side of a sheet and a first conveying means for conveying the sheet in a predetermined direction; a cutter device provided on the output side of the printing device and adapted to cut the sheet in a predetermined length; and a stocking mechanism having a member forming a cylindrical or spiral space for temporarily stocking the sheet.

4. A printer according to claim 3, wherein the stocking mechanism further comprises a conveying means for performing one of introducing the sheet into the cylindrical or spiral space and extracting the sheet from the cylindrical or spiral space.

5. A printer comprising: a printing device having a printing means for printing on one side of a sheet and a first conveying means for conveying the sheet in a predetermined direction; a cutter device provided on the output side of the printing device and adapted to cut the sheet in a predetermined length; a stocking mechanism having a member forming a cylindrical or spiral space for temporarily stocking the sheet; and a thermal activation unit provided on the output side of the stocking mechanism and having a heating means for heating the other side of the sheet and a second conveying means for conveying the sheet in a predetermined direction.

6. A printer according to claim 5, wherein the stocking mechanism further comprises a conveying means for performing one of introducing the sheet into the cylindrical or spiral space and extracting the sheet from the cylindrical or spiral space toward the thermal activation unit.

7. A printer according to claim 5, wherein the thermal activation unit heats a heat sensitive adhesive agent layer of a heat sensitive adhesive sheet, which has on one side a printable layer and on the other side the heat sensitive adhesive agent layer, to cause the heat sensitive adhesive agent layer to develop adhesiveness.

8. A printer comprising: a first printing device having a first printing means for printing on one side of a sheet and a first conveying means for conveying the sheet in a predetermined direction; a cutter device provided on the output side of the first printing device and adapted to cut the sheet in a predetermined length; a stocking mechanism having a member forming a cylindrical or spiral space for temporarily stocking the sheet; and a second printing device provided on the output side of the stocking mechanism and having a second printing means for printing on the other side of the sheet and a second conveying means for conveying the sheet in a predetermined direction.

9. A printer according to claim 8, wherein the stocking mechanism further comprises a conveying means for performing one of introducing the sheet into the cylindrical or spiral space and extracting the sheet from the cylindrical or spiral space toward the second printing device.
